(19) United States
(12) Patent Application Publication
(10) Pub. No.: US 2026/0202573 A1
(43) Pub. Date: Jul. 16, 2026

(54) DOWNHOLE TOOLS THAT INCLUDE A RADIATION DETECTOR AND PROCESSES FOR USING SAME

(71) Applicant: SCHLUMBERGER TECHNOLOGY CORPORATION, Sugar Land, TX (US)

(72) Inventors: Markus BERHEIDE, Cambridge, MA (US); Sicco BEEKMAN, Sugar Land, TX (US); Olivier PHILIP, Sugar Land, TX (US); Irina SHESTAKOVA, Princeton, NJ (US)

(21) Appl. No.: 19/136,869

(22) PCT Filed: Dec. 8, 2023
(86) PCT No.: PCT/US2023/083163

§ 371 Date: Jun. 7, 2025

Related U.S. Application Data
(60) Provisional application No. 63/386,511, filed on Dec. 8, 2022.

(51) Int. Cl. G01V 5/10; G01T 1/202

(52) U.S. Cl. CPC G01V 5/101; G01T 1/2023

(57) ABSTRACT

Downhole tools and processes for using same to detect radiation via scintillation. In some embodiments, the downhole tool can be deployable in a wellbore that traverses a formation. The downhole tool can include a tool housing configured for movement within and along the wellbore. The downhole tool can include a radiation detector that includes a scintillator material disposed within the tool housing. The scintillator material can include a cerium-activated gadolinium pyrosilicate. In some embodiments, the cerium-activated gadolinium pyrosilicate can have a chemical formula of: (Gd_{1-x-y}CeₓA_{y})₂Si₂O₇, where: x can be equal to 0.001 to 0.08, y can be equal to 0 or can be a number from 0.0001 to 0.079, if y is >0, A can include at least one rare-earth element selected from the group consisting of: Sc, Y, La, Pr, Nd, Pm, Sm, Eu, Tb, Dy, Ho, Er, Tm, Yb, and Lu, and 1-x-y can be ≥0.92.

### CROSS-REFERENCE TO RELATED APPLICATIONS

The present application is an International Application that claims priority to U.S. Provisional Ser. No. 63/386,511 that was filed on Dec. 8, 2022, which is herein incorporated by reference in its entirety.

### FIELD

Embodiments described herein generally relate to downhole tools that include a radiation detector and processes for using same. More particularly, such embodiments relate to downhole tools that include a radiation detector that includes a scintillator material disposed within a tool housing, where the scintillator material includes a cerium-activated gadolinium pyrosilicate and processes for using same.

### BACKGROUND

The properties of conventional gamma-ray scintillation detectors used in the oilfield industry in carrying out downhole operations often change properties as the temperature changes. A major disadvantage of most known scintillator materials is that light output from the scintillator material significantly drops as the temperature increases. For example, the common NaI(Tl) scintillator material can lose one third of its light output or more at typical temperatures that exist downhole. This causes the energy resolution of the detector to drop, which in turn reduces the signal-to-noise ratio and increases statistical uncertainty.

One workaround to reduce or minimize property changes in conventional gamma-ray scintillation detectors is through the use of passive cooling. Passive cooling of gamma-ray scintillation detectors, however, increases the cost and complexity of the detectors.

There is a need, therefore, for improved gamma-ray scintillation detectors and processes for using same.

### SUMMARY

Downhole tools and processes for using same in detecting radiation via scintillation are provided. In some embodiments, a downhole tool deployable in a wellbore that traverses a formation can include a tool housing configured for movement within and along the wellbore; and a radiation detector that can include a scintillator material disposed within the tool housing. The scintillator material can be or can include a cerium-activated gadolinium pyrosilicate.

In some embodiments, a process for determining at least one property of a formation having a wellbore drilled therein can include lowering a downhole tool into the wellbore. The downhole tool can include a tool housing that can include a radiation detector disposed therein. The radiation detector can include a scintillator material optically coupled to a photodetector. The scintillator material can include a cerium-activated gadolinium pyrosilicate. The process can also include absorbing natural gamma-rays incoming from the formation with the scintillator material. The process can also include emitting light from the scintillator material in response to the absorbed natural gamma-rays. The process can also include detecting at least a portion of the light emitted from the scintillator material with the photodetector. The process can also include determining the at least one property of the formation based at least in part on the light detected by the photodetector.

In other embodiments, a process for determining at least one property of a formation having a wellbore drilled therein can include lowering a downhole tool into the wellbore. The downhole tool can include a tool housing that can include a radiation detector that includes a radiation source, a scintillator material, and a photodetector disposed therein. The scintillator material can be optically coupled to the photodetector. The scintillator material can include a cerium-activated gadolinium pyrosilicate. The radiation source can include at least one of a neutron source, a gamma-ray source, and an x-ray source. The process can also include emitting outgoing radiation from the radiation source into the formation. The process can also include absorbing incoming radiation resulting from interactions between the outgoing radiation and the formation with the scintillator material. The process can also include emitting light from the scintillator material in response to the absorbed radiation. The process can also include detecting at least a portion of the light emitted from the scintillator material with the photodetector. The process can also include determining the at least one property of the formation based at least in part on the light detected by the photodetector.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the views of the drawings.

FIG. 1 depicts an illustrative system for determining one or more formation properties using radiation measurements, according to one or more embodiments described.

FIG. 2 depicts an illustrative downhole tool in a wellbore, according to one or more embodiments described.

FIG. 3 depicts a room temperature pulse height spectrum of a Cs-source measured with an inventive radiation detector and a comparative radiation detector.

FIG. 4 depicts data points for the light output relative to room temperature light output of the inventive radiation detector.

FIG. 5 depicts a plot of data from the inventive radiation detector in which the scintillation decay curve was approximated by a three-exponential decay, and that shows the two dominating individual decay times plotted against temperature.

FIG. 6 depicts a plot of data from the inventive radiation detector in which the scintillation decay curve was approximated by a three-exponential decay that shows the fraction of the total light transmission for the three decay components in the fit.

FIG. 7 depicts a spectrum of natural background taken with the inventive radiation detector. The x-axis shows the relative peak height of the signal in channel numbers at the given multi-channel analyzer settings and the y-axis shows the number of counts per channel.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the claims.

Embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

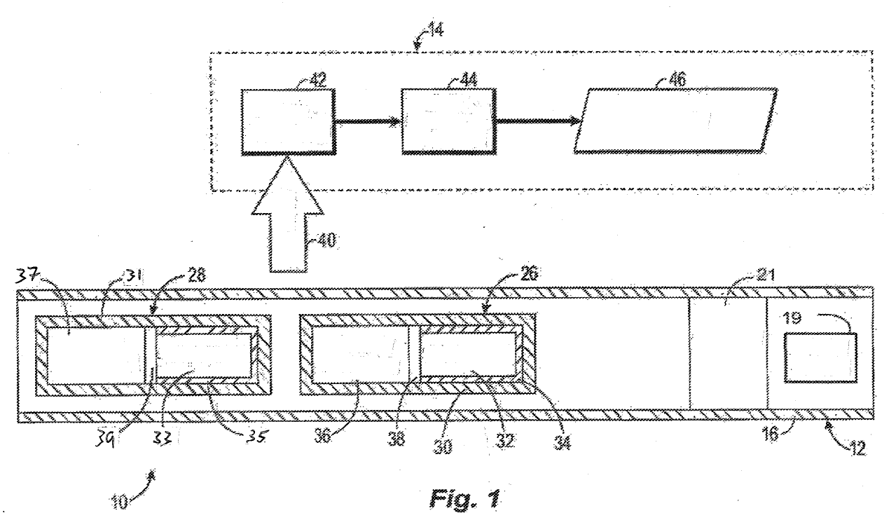

FIG. 1 depicts an illustrative system 10 for determining one or more formation properties using radiation measurements, according to one or more embodiments. The system 10 can include a downhole tool 12 and a data processing system 14. By way of example, the downhole tool 12 can be a slickline or wireline tool for logging an existing well or can be installed in a borehole assembly for logging while drilling (LWD). The data processing system 14 can be incorporated into the downhole tool 12 or can be at the surface at the wellsite or another remote location.

In some embodiments, the downhole tool 12 can include a tool housing 16 that can be configured for movement within and along a wellbore that traverses a formation. In some embodiments, the housing 16 can be made from stainless steel, titanium, cobalt-free steel, or any other suitable material. One or more radiation detectors (two are shown, 26 and 28) can be disposed within the tool housing 16. The number of radiation detectors the downhole tool 12 includes can be 1, 2, 3, 4, 5, 6, or more.

In some embodiments, each radiation detectors 26 and 28 can be surrounded by a housing 30 and 31, respectively. In other embodiments, the radiation detector 26 and/or 28 can be free of the housings 30 and/or 31, respectively. The radiation detectors 26 and 28 can each include a scintillator material 32 and 33, respectively. In some embodiments, the scintillator materials 32 and 33 can have the same composition or can have different compositions with respect to one another. At least one of the scintillator materials 32 and 33 can include a cerium-activated gadolinium pyrosilicate. In some embodiments, the scintillator materials 32 and 33 can both include a cerium-activated gadolinium pyrosilicate.

In some embodiments, the scintillator materials 32 and 33 can emit light when the scintillator materials 32 and 33 absorb radiation incoming from the formation. In some embodiments, the radiation can be natural radiation, e.g., natural gamma rays, incoming from the formation. In other embodiments, the downhole tool 12 can include one or more radiation sources 19 that can be configured to emit outgoing radiation into the formation. In such embodiment, when the radiation source 19 emits outgoing radiation, the scintillator materials 32 and 33 can emit light when the scintillator materials 32 and 33 absorb incoming radiation, e.g., gamma-rays, resulting from interactions between the outgoing radiation and the formation. In some embodiments, the radiation source 19 can emit at least one of neutrons, gamma-rays, and x-rays. In some embodiments, the radiation source 19 can be an electronic radiation source or a mass of radioactive material.

In some embodiments, the mass of radioactive material can be ¹³⁷Cs that can emit gamma-rays into the formation. In some embodiments, the mass of radioactive material can be ²⁴¹Am-Be that can emit neutrons into the formation. In other embodiments, in lieu of a mass of radioactive material, an electronic radiation source can be used. In some embodiments, the electronic radiation source can be a neutron generator that can produce both neutrons and gamma-rays. To do so, the electronic neutron generator can emit neutrons into a formation, which can in turn produce gamma-rays via inelastic scattering and neutron capture events. In some embodiments, the electronic neutron generator can be a pulsed electronic neutron source. Radiation sources that can be used in the downhole tool 12 disclosed herein are well-known in the art. In some embodiments, suitable radiation sources can include those described in U.S. Pat. Nos. 6,032,102; 8,642,944; 8,901,483; 8,865,011; 8,901,483; 9,599,729; 9,995,841; 10,145,979; 10,591,630.

The number of radiation sources 19 the downhole tool 12 can include can be 1, 2, 3, 4, or more. When the downhole tool 12 includes two or more radiation sources, each radiation source can emit the same type of radiation or different types of radiation. When the downhole tool 12 includes two or more radiation sources, each radiation source can be operated independent of one another. It should be understood that, in some embodiments, the downhole tool 12 can be free of any radiation source 19 such that the downhole tool 12 can be configured to detect only natural radiation incoming from the formation. In other embodiments, however, the downhole tool 12 can include at least one radiation source 19. When the downhole tool 12 includes at least one radiation source 19, the scintillator materials 32, 33 can be configured to emit light when the scintillator materials 32, 33 absorb natural radiation incoming from the formation and/or when the scintillator materials 32, 33 absorb incoming radiation resulting from interactions between the outgoing radiation emitted from the radiation source 19 and the formation.

When the downhole tool 12 includes the radiation source 19, the radiation detector 26 can be referred to as a first or “near” radiation detector and the radiation detector 28 can be referred to as a second or “far” radiation detector. As should be appreciated, the near radiation detector 26 and the far radiation detector 28 are so named due to their relative proximity to the radiation source 19. In some embodiments, the scintillator material 32 of the near radiation detector 26 can be located approximately 20 cm to 56 cm from the radiation source 19, while the scintillator material 33 of the far radiation detector 28 can be located approximately 38 cm to 92 cm from the radiation source 19.

It has been discovered that the cerium-activated gadolinium pyrosilicate exhibits significantly improved performance when used as the scintillator materials 32 and 33 in the downhole tool 12 as compared to a gadolinium oxy-orthosilicate reference material. The cerium-activated gadolinium pyrosilicate can produce a high light yield and has exceptional temperature stability. More particularly, the cerium-activated gadolinium pyrosilicate emits at least three times the light output as compared to the gadolinium oxy-orthosilicate reference material. A higher light output yields an improved signal-to-noise ratio and better energy resolution. The cerium-activated gadolinium pyrosilicate also exhibits a variation of several performance characteristics over a temperature range from 25° C. to 175° C., 180° C., 185° C., 190° C., 195° C., 200° C., 205° C., or 210° C. that is less than 20%, where each decay time component stays within 20% of the room temperature value over the same temperature range. Furthermore, the cerium-activated gadolinium pyrosilicate does not exhibit substantial intrinsic radioactivity. Additionally, the cerium-activated gadolinium pyrosilicate is substantially free of internal radioactive background. The cerium-activated gadolinium pyrosilicate also features scintillation in which the wavelength of the light emission matches the region of highest quantum efficiency for high temperature photo-multiplier tubes. The cerium-activated gadolinium pyrosilicate is also not hygroscopic, which greatly simplifies the construction of the downhole tool 12.

The cerium-activated gadolinium pyrosilicate can have a chemical formula of: (Gd_{1-x-y}CeₓA_{y})₂Si₂O₇, where: x can be equal to 0.001 to 0.08, y can be equal to 0 or is a number from 0.0001 to 0.08, if y is >0, A can include at least one rare-earth element selected from the group consisting of: Sc, Y, La, Pr, Nd, Pm, Sm, Eu, Tb, Dy, Ho, Er, Tm, Yb, and Lu, and 1-x-y can be ≥0.92. In some embodiments, x can be greater than y. In some embodiments, x can be equal to 0.001, 0.002, 0.003, 0.004, 0.005, 0.007, 0.01, 0.02, or 0.03 to 0.04, 0.05, 0.06, 0.07, or 0.08. In some embodiments, x can be≥0.001,≥0.0015,≥0.002 and <0.005,<0.0045,<0.004, <0.0035, <0.003, or <0.0025. In some embodiments, y can be 0. In some embodiments, 1-x-y can be ≥0.925,≥0.930,≥0.935,≥0.940or ≥0.945 and ≤0.970,≤0.980,≤0.990,or ≤0.999.

In some embodiments, a total amount of any radioactive rare-earth isotopes in the cerium-activated gadolinium pyrosilicate can be <5%, <4.5%, <4%, <3.5%, <3%, <2.5%, <2%, <1.5%, <1%, <0.5%, or <0.1%. In some embodiments, the cerium-activated gadolinium pyrosilicate can be free of any radioactive rare-earth isotope. In some embodiments, when y is >0, A can include La, Lu, or a combination thereof. In some embodiments, the cerium-activated gadolinium pyrosilicate can be a single crystal. In some embodiments, the cerium-activated gadolinium pyrosilicate can be a single crystal in the form of a cylinder, a rectangular parallelepiped, or cube. In some embodiments, the cerium-activated gadolinium pyrosilicate in the form of a single crystal can have a volume of at least 1 cm³, at least 1.1 cm³, at least 1.2 cm³, at least 1.3 cm³, at least 1.4 cm³, at least 1.5 cm³, at least 1.6 cm³, or at least 1.7 cm³.

The cerium-activated gadolinium pyrosilicate in the form of a single crystal can be made via any suitable crystal growing process. The process for making the cerium-activated gadolinium pyrosilicate in the form of a single crystal can include melting the raw materials to produce a molten liquid and at least a part of a seed crystal can be immersed in the molten liquid. By cooling and solidifying the molten liquid the single crystal can be grown along a predetermined crystal plan orientation to produce the single crystal. The single crystal can then be cut or otherwise formed into a desired shape. In some embodiments, the melting step can be a rotary pulling method such as the well-known Czochralski method or the top seeded solution growth method. The raw materials can include any suitable compounds. In some embodiments, the raw materials used to make the cerium-activated gadolinium pyrosilicate can be or can include, but are not limited to, gadolinium oxide, cerium oxide, and silicon oxide. If y is >0, suitable raw materials for A can be or can include, but are not limited to, lanthanum oxide, lutetium oxide, yttrium oxide, samarium oxide, and so on.

In some embodiments, when the cerium-activated gadolinium pyrosilicate absorbs radiation incoming from the formation, the cerium-activated gadolinium pyrosilicate can emit light at a light output that varies by less than 20%, less than 19%, less than 18%, less than 17%, less than 16%, less than 15%, less than 14%, less than 13%, less than 12%, less than 11%, or less than 10% at any temperature within a range from 20° C. to 175° C., 180° C., 185° C., 190° C., 195° C., 200° C., 205° C., or 210° C. In some embodiments, when the cerium-activated gadolinium pyrosilicate absorbs radiation incoming from the formation, the cerium-activated gadolinium pyrosilicate can emit the light at a light output of at least 20,000 ph/MeV, at least 25,000 ph/MeV, at least 30,000 ph/MeV, at least 35,000 ph/MeV, at least 40,000 ph/MeV, or at least 42,000 ph/MeV at any temperature within a range from 20° C. to 175° C., 180° C., 185° C., 190° C., 195° C., 200° C., 205° C., or 210° C.

In some embodiments, when the cerium-activated gadolinium pyrosilicate absorbs radiation incoming from the formation, the cerium-activated gadolinium pyrosilicate can have a primary decay time component of which a decay constant varies by 20% or less, 19% or less, 18% or less, 17% or less, 16% or less, 15% or less, 14% or less, 13% or less, 12% or less 11% or less, or 10% or less at any temperature within a range from 20° C. to 175° C., 180° C., 185° C., 190° C., 195° C., 200° C., 205° C., or 210° C. In some embodiments, when the cerium-activated gadolinium pyrosilicate absorbs radiation incoming from the formation, the cerium-activated gadolinium pyrosilicate can have a secondary decay time component of which a decay constant varies by 20% or less, 19% or less, 18% or less, 17% or less, 16% or less, 15% or less, 14% or less, 13% or less, 12% or less 11% or less, or 10% or less at any temperature within a range from 20° C. to 175° C., 180° C., 185° C., 190° C., 195° C., 200° C., 205° C., or 210° C.

In some embodiments, when the cerium-activated gadolinium pyrosilicate absorbs radiation incoming from the formation, the cerium-activated gadolinium pyrosilicate can have a primary decay time component of less than 120 ns, less than 117 ns, less than 115 ns, less than 112 ns, less than 110 ns, or less than 105 ns at any temperature within a range from 20° C. to 175° C., 180° C., 185° C., 190° C., 195° C., 200° C., 205° C., or 210° C. In some embodiments, when the cerium-activated gadolinium pyrosilicate absorbs radiation incoming from the formation, the cerium-activated gadolinium pyrosilicate can have a primary decay time component within a range from 80 ns, 83 ns, 85 ns, 87 ns, or 90 ns to 95 ns, 100 ns, 104 ns, 108 ns, 112 ns, 116 ns, or 119 ns at any temperature within a range from 20° C. to 175° C., 180° C., 185° C., 190° C., 195° C., 200° C., 205° C., or 210° C.

In some embodiments, when the cerium-activated gadolinium pyrosilicate absorbs radiation incoming from the formation, the cerium-activated gadolinium pyrosilicate can have a secondary decay time component of less than 200 ns, less than 197 ns, less than 195 ns, less than 193 ns, less than 190 ns, less than 187 ns, or less than 185 ns at any temperature within a range from 20° C. to 175° C., 180° C., 185° C., 190° C., 195° C., 200° C., 205° C., or 210° C. In some embodiments, when the cerium-activated gadolinium pyrosilicate absorbs radiation incoming from the formation, the cerium-activated gadolinium pyrosilicate can have a secondary decay time component within a range from 155 ns, 160 ns, 165 ns, or 172 ns to 182 ns, 185 ns, 190 ns, 195ns, or 199 ns at any temperature within a range from 20° C. to 175° C., 180° C., 185° C., 190° C., 195° C., 200° C., 205° C., or 210° C.

In some embodiments, when the cerium-activated gadolinium pyrosilicate absorbs radiation incoming from the formation, the cerium-activated gadolinium pyrosilicate can have a light decay that can be approximated by a two-exponential decay for at least 95% of the light output within 2 microseconds. In some embodiments, when the cerium-activated gadolinium pyrosilicate absorbs radiation incoming from the formation, the cerium-activated gadolinium pyrosilicate can have a primary decay time component that includes at least 50% of the light emitted within 1 microsecond.

In some embodiments, when the cerium-activated gadolinium pyrosilicate absorbs radiation incoming from the formation, a fraction of the light emitted within 1 microsecond that is not covered by the primary and secondary decay constants can be less than 10%, less than 9%, less than 8%, less than 7%, less than 6% or less than 5% of the total light output at any temperature within a range from 20° C. to 175° C., 180° C., 185° C., 190° C., 195° C., 200° C., 205° C., or 210° C. In some embodiments, when the cerium-activated gadolinium pyrosilicate absorbs radiation incoming from the formation, any decay time component greater than 300 ns can contribute to less than 5%, less than 4%, or less than 3.5% of the light output.

Returning to the downhole tool 12, in some embodiments, a shield layer 34 and/or 35 can optionally be disposed about the scintillator materials 32 and 33, respectively. In some embodiments, the shield layers 34 and 35 can be configured to reduce production of epithermal neutron capture gamma-rays. In some embodiments, the optional shield layers 34 and 35 can be or can include, but is not limited to, a material enriched with the isotope Li, which has a relatively high thermal neutron capture cross section, but also produces primarily charged particles in lieu of gamma-rays. Candidate materials include lithium carbonate (Li₂CO₃) embedded in epoxy or metallic lithium hermetically sealed in a metal can. When the radiation detectors 26 and 28 include the optional shield layers 34 and 35 thermal neutrons that reach the thermal neutron shields 34, 35 can be absorbed without the production of neutron capture gamma-rays.

In some embodiments, as shown, the radiation detectors 26, 28 can each include a photodetector 36 and 37 disposed within the housings 30 and 31 of the radiation detectors 26 and 28, respectively. In other embodiments, as noted above, the radiation detector 26 and/or 28 can be free of the housings 30 and/or 31, respectively. Suitable photodetectors 36 and 37 that can be used in the downhole tool 12 are well-known in the art. In some embodiments, the photodetectors 36 and 37 can be photomultiplier tubes, preferably high temperature photomultiplier tubes. Photomultiplier tubes 36, 37 can receive photons emitted by the scintillator materials 32, 33 and, in-turn, generate a current pulse for radiation, e.g., a gamma-rays, that strikes the scintillator materials 32, 33. The magnitude of the current pulse can be related to the energy of the impacting radiation. In other embodiments, the photodetectors 36 and/or 37 can be another type of photodetector that produces a current pulse, or, with appropriate adjustments to the circuitry, a voltage pulse, for radiation, e.g., gamma-rays, that strikes the scintillator materials 32, 33, which are well-known in the art. In some embodiments, suitable photodetectors that can be used in the downhole tool 12 can include those described in U.S. Pat. Nos. 8,173,953; 8,536,517; 8,546,749; 8,901,483; 9,304,226; 10,145,979; and 10,591,630.

The photodetectors 36 and 37 can be optically coupled to the scintillator materials 32 and 33, respectively. In some embodiments, an optical window 38 and 39 can be disposed between the photodetectors 36 and 37 and the scintillator materials 32 and 33, respectively. In some embodiments, the optical windows 38 and 39 can be sapphire or glass, as noted in U.S. Pat. No. 4,360,733. In some embodiments, optical contact between the scintillator materials 32, 33 and the windows 38, 39 can be established using an internal optical coupling pad that includes a transparent silicone rubber disk, as noted in U.S. Pat. No. 8,889,036. The photodetectors 36 and 37 can be configured to detect light emitted from the scintillator materials 32 and 33, respectively. In other embodiments, a single photodetector can be optically coupled to both of the scintillator materials 32, 33.

In some embodiments, the photodetectors 36 and/or 37 can be a photomultiplier tube that can include a window made from the cerium-activated gadolinium pyrosilicate. In such embodiment, the photodetectors 36 and/or 37 can be used as the radiation detectors 26 and/or 28 without the need for the additional scintillator materials 32 and/or 33. In other embodiments, if the photodetectors 36 and/or 37 are photomultiplier tubes that include a window made from the cerium-activated gadolinium pyrosilicate, the additional scintillator materials 32 and/or 33 can still be present. In such embodiment, the window of the photodetectors 36 and/or 37 that can be made from the cerium-activated gadolinium pyrosilicate can improve light transmission when coupled to the scintillator materials 32 and/or 33 as compared to other window materials such as sapphire or glass.

As noted above, the photodetectors 36 and 37 can generate signals, e.g., a current or voltage pulse, in response to light detected that can be emitted from the scintillator materials 32, 33, respectively. The signals generated by the photodetectors 36 and 37 can be processed to determine at least one property of the formation based at least in part on the generated signals, as further described below.

In some embodiments, the downhole tool 12 can include a radiation shield 21 disposed between the radiation source 19 and the radiation detectors 26, 28. The radiation shield 21 can be configured to shield the radiation detectors 26 and 28 from gamma-rays, neutrons, and/or x-rays. Materials suitable for use as the radiation shield 21 are well-known. For example, a suitable radiation shield can include elements with high (n,2n) cross sections, such as lead, bismuth, and/or tungsten.

The signals from the radiation detectors 26 and/or 28 can be transmitted to the data processing system 14 as data 40. The data processing system 14 can be or can include, but is not limited to a general-purpose computer, such as a personal computer, configured to run a variety of software, including software implementing all or part of the present technique. Alternatively, the data processing system 14 can be or can include, but is not limited to, a mainframe computer, a distributed computing system, or an application-specific computer or workstation configured to implement all or part of the present technique based on specialized software and/or hardware provided as part of the system. Further, the data processing system 14 may include either a single processor or a plurality of processors to facilitate implementation of the presently disclosed functionality.

In general, the data processing system 14 can include data processing circuitry 44, which can be a microcontroller or microprocessor, such as a central processing unit (CPU), which can execute various routines and processing functions. For example, the data processing circuitry 44 can execute various operating system instructions as well as software routines configured to effect certain processes and stored in or provided by a manufacture including a computer readable-medium, such as a memory device (e.g., a random access memory (RAM) of a personal computer) or one or more mass storage devices (e.g., an internal or external hard drive, a solid-state storage device, CD-ROM, DVD, or other storage device). In addition, the data processing circuitry 44 can process data provided as inputs for various routines or software programs, including the data 40.

Such data associated with the present techniques can be stored in, or provided by, the memory or mass storage device of the data processing system 14. Alternatively, such data can be provided to the data processing circuitry 44 of the data processing system 14 via one or more input devices. In one embodiment, data acquisition circuitry 42 can represent one such input device; however, the input devices can also include manual input devices, such as a keyboard, a mouse, or the like. In addition, the input devices may include a network device, such as a wired or wireless ethernet card, a wireless network adapter, or any of various ports or devices configured to facilitate communication with other devices via any suitable communications network, such as a local area network or the Internet. Through such a network device, the data processing system 14 can exchange data and communicate with other networked electronic systems, whether proximate to or remote from the system. The network can include various components that facilitate communication, including switches, routers, servers or other computers, network adapters, communications cables, and so forth.

The downhole tool 12 can transmit the data 40 to the data acquisition circuitry 42 of the data processing system 14 via, for example, a telemetry system communication downlink or a communication cable. After receiving the data 40, the data acquisition circuitry 42 can transmit the data 40 to data processing circuitry 44. In accordance with one or more stored routines, the data processing circuitry 44 can process the data 40 to ascertain one or more properties of a subterranean formation surrounding the downhole tool 12. Such processing can involve, for example, one or more techniques for removing an epithermal neutron capture background from a gamma-ray count. The data processing circuitry 44 can thereafter output a report 46 indicating the one or more ascertained properties of the formation, such as porosity logging, density logging, natural gamma-ray logging, gamma-ray spectroscopy, density-porosity logging, gas saturation, and so on. The report 46 can be stored in memory or can be provided to an operator via one or more output devices, such as an electronic display and/or a printer.

In some embodiments, when the scintillator material 32 and/or 33 includes the cerium-activated gadolinium pyrosilicate, the signals from the radiation detectors 26 and/or 28, i.e., the signals produced by the photodetectors 36 and/or 37, can be processed using a pulse shaping filter based on a set of decay time constants that can be independent of temperature. In other words, the set of decay time constants used to process the signals produced by the photodetectors 36 and/or 37 can be pre-determined or otherwise fixed and not varied based on a temperature of the scintillator material 32 and/or 33 when the radiation is absorbed by and the light is emitted from the scintillator material 32 and/or 33, when the scintillator material 32 and/or 33 is at a temperature in a range from 20° C. to 175° C., 180° C., 185° C., 190° C., 195° C., 200° C., 205° C., or 210° C.

In some embodiments, when the scintillator material 32 and/or 33 includes the cerium-activated gadolinium pyrosilicate, the signals produced by radiation detectors 26 and/or 28, i.e., the photodetectors 36 and/or 37, can be processed using a pulse shaping filter in which a single variable that compensates for changes in a set of decay time constants can be used, and the range of the variable can be less than 20%, less than 19%, less than 18%, less than 17%, less than 16%, less than 15%, less than 14%, less than 13%, less than 12%, less than 11%, or less than 10% of the total value of the variable when the scintillator material 32 and/or 33 is at a temperature in a range from 20° C. to 175° C., 180° C., 185° C., 190° C., 195° C., 200° C., 205° C., or 210° C.

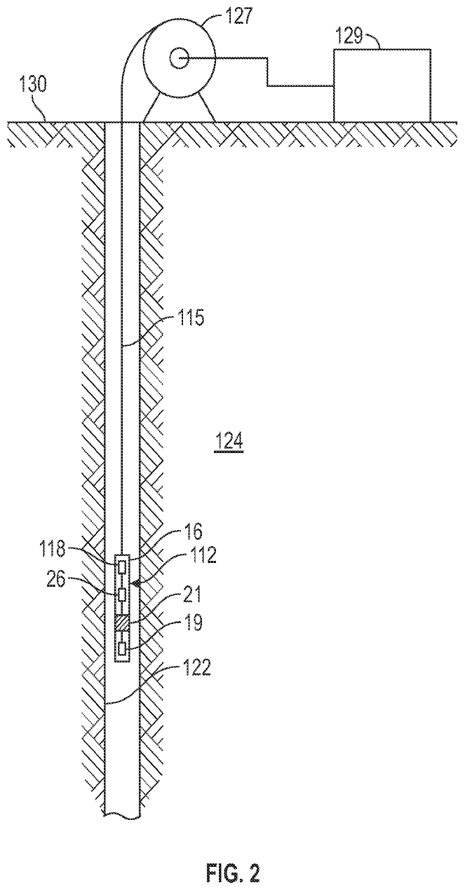

FIG. 2 depicts an illustrative downhole tool 112 in a wellbore 122, according to one or more embodiments. The downhole tool 112 can be similar to the downhole tool 12 described above with reference to FIG. 1. In some embodiments, in addition to the radiation source 19, the radiation shield 21, and a radiation detector 26, the downhole tool 112 can also include a pulse height analyzer and telemetry unit 118 disposed within the housing 16. The downhole tool 112 can be configured to move along the wellbore 122 drilled through subsurface formations 124. In some embodiments, the downhole tool 112 can be moved along the wellbore 122 by an armored electrical cable 115. The cable 115 can be extended and retracted by a winch 127 or similar spooling device known in the art. Electrical power to operate the downhole tool 112 can be provided by a recording unit 129 disposed on the surface 130. The recording unit 129 can include equipment (not shown separately) for detecting, recording, and interpreting signals transmitted from the downhole tool 112 as it moves along the wellbore 122. The example device for conveying the downhole tool 112 along the wellbore (cable 115 and winch 127) are only shown to provide an example of conveyance that can be used with the downhole tool 112. Other devices known in the art that can be used to convey the downhole tool 112 along the wellbore 122, can include, but are not limited to, coiled tubing, drill pipe (including logging while drilling), production tubing, and slickline. Accordingly, the conveyance shown in FIG. 2 is not intended to limit the scope of the present invention.

As discussed above, the radiation detected by the scintillator material in the radiation detector 26 can result in electrical pulses produced by the photodetector in the radiation detector 26 in response to light emitted from the scintillator material. In some embodiments, such electrical pulses can be communicated to the pulse height analyzer and telemetry unit 118 that can be disposed within the downhole tool 112. The pulse height analyzer and telemetry unit 118 can impart signals to the cable 115 that correspond to the numbers of and energy levels of the detected radiation. Alternatively or additionally, the pulse height analyzer and telemetry unit 118 can include signal recording devices for storage of analyzed electrical pulses from the radiation detector 26 for interrogation when the downhole tool 112 is withdrawn from the wellbore 122.

While subterranean use is of particular interest, scintillators and scintillation detectors of the invention may be used in any field or industry where usage of such types of crystals and devices is known, including but not limited to chemistry, physics, space exploration, nuclear medicine, energy industry use, devices for determination of weights and measurements in any industry, and the like, without limitation.

### EXAMPLES

The foregoing discussion can be further described with reference to the following non-limiting examples. An inventive radiation detector was made according to one or more embodiments described herein and tested. The scintillator material in the inventive radiation detector was a cerium-activated gadolinium pyrosilicate single crystal that had a chemical formula of (Gd0.975Ce0.025)2Si2O7. The cerium-activated gadolinium pyrosilicate single crystal had a 12 mm diameter and a 12 mm length. A comparative radiation detector was also made and tested. The only difference between the comparative radiation detector and the inventive radiation detector was that the scintillator material was a cerium-activated gadolinium oxy-orthosilicate single crystal that had a chemical formula of (Gd0.985Ce0.015)2SiO5. The cerium-activated gadolinium oxy-orthosilicate single crystal had a 12 mm diameter and a 12 mm length.

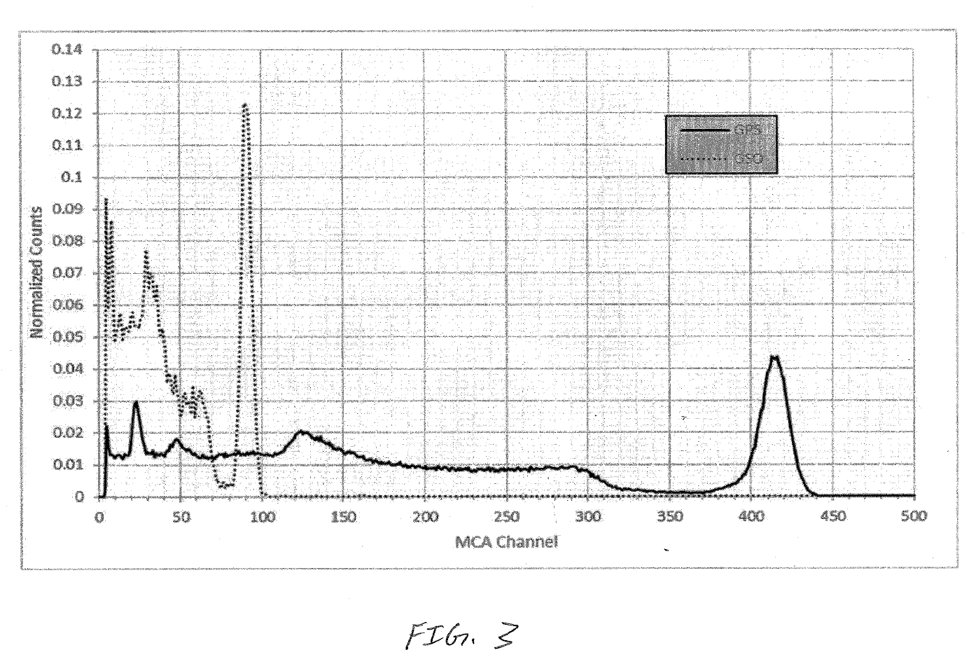

FIG. 3 depicts the room temperature pulse height spectrum of a Cs-source measured with the inventive radiation detector and the comparative radiation detector. The pulse height spectrum obtained from the inventive radiation detector is shown in a solid line and the pulse height spectrum obtained from the comparative detector is shown in the dashed line. The same photomultiplier and the same high voltage were used in both cases. The full energy peak of the Cs-source appears at approximately channel 414 for the inventive radiation detector and at channel 91 for the comparative radiation detector. After correction for quantum efficiency of the photomultiplier tube, the pulse height spectra indicated that the inventive radiation detector had more than three times the light output as compared to the comparative radiation detector. The full-width-of-half-maximum (FWHM) energy resolution of the Cs full energy peak (661.7 keV) for the inventive radiation detector was approximately 4.7%, which was significantly better than the comparative radiation detector that was approximately 8.2%. The resolution of a typical thallium-doped sodium iodide (NaI(Tl)) crystal under comparable conditions rarely exceeds 6.8%.

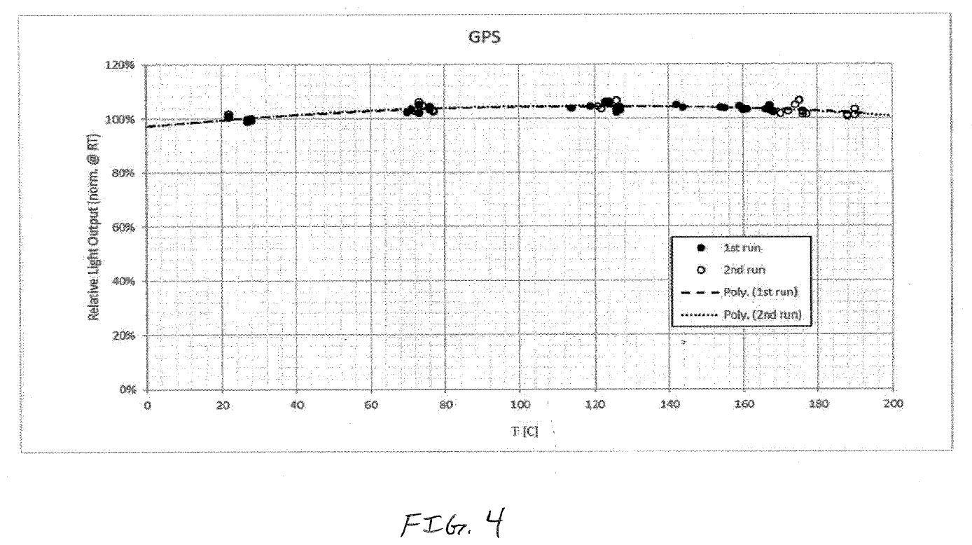

FIG. 4 depicts data points for the relative light output of the inventive radiation detector. The temperature range went from about 20° C. to about 190° C. The light output was normalized at room temperature. In addition to the data from two separate runs, the trendlines are shown with polynomial fits. In this implementation, the variation in light output was less than 10% of the entire temperature range.

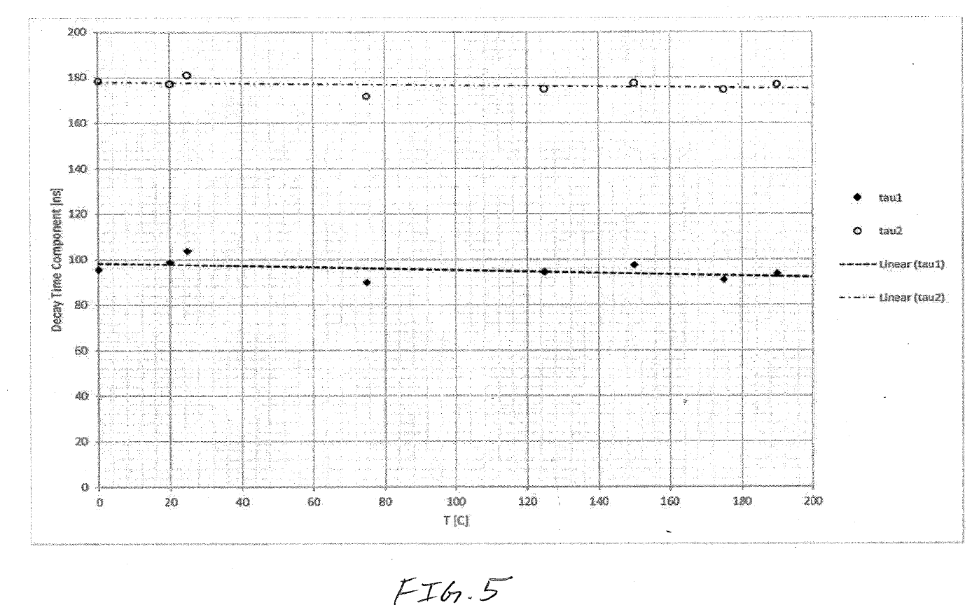

FIG. 5 depicts a plot of data from the inventive radiation detector in which the scintillation decay curve was approximated by a three-exponential decay that shows the individual decay times plotted against temperature. Only two of the decay time components were significant (over 5% of the total). The primary component was about 90 ns to 104 ns over the temperature range from about 20° C. to about 190° C. The secondary decay was about 172 ns to about 182 ns over the temperature range from about 20° C. to about 190° C.

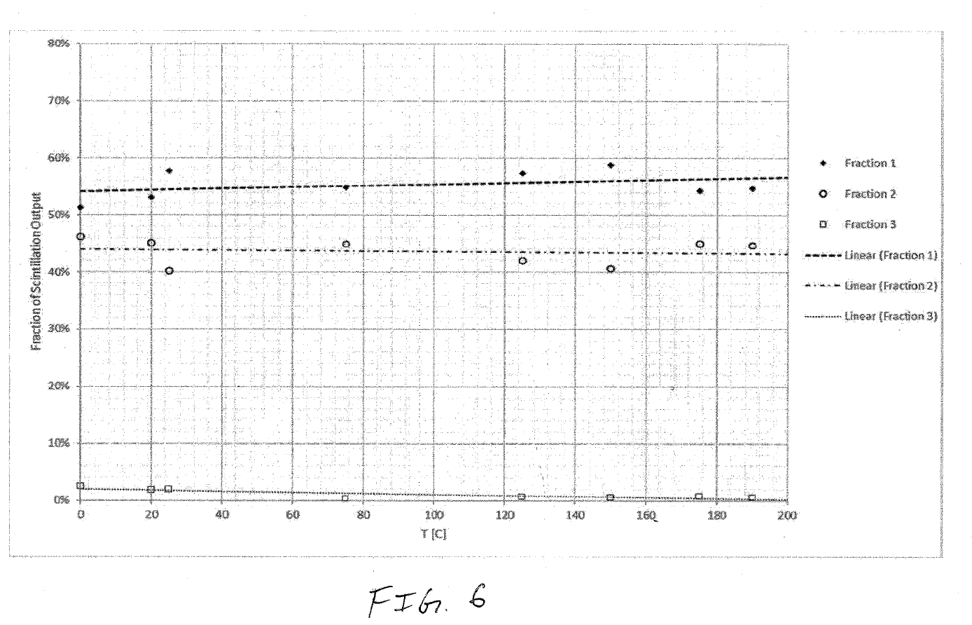

FIG. 6 depicts a plot of data from the inventive radiation detector in which the scintillation decay curve was approximated by a three-exponential decay that shows the fraction of the total light transmission for the three decay components in the fit. Only two of the decay time components shown in FIG. 6 were significant (over 3% of the total). The fraction of the primary decay component varied from 51% to 59% of the total light yield over the temperature range from about 20° C. to about 190° C. The fraction of the secondary decay component varied from about 40% to about 46% of the total light yield over the temperature range of about 20° C. to about 190° C. A longer component of a few microseconds was less than 3% of the total light output and for that reason was not explicitly shown in FIG. 5.

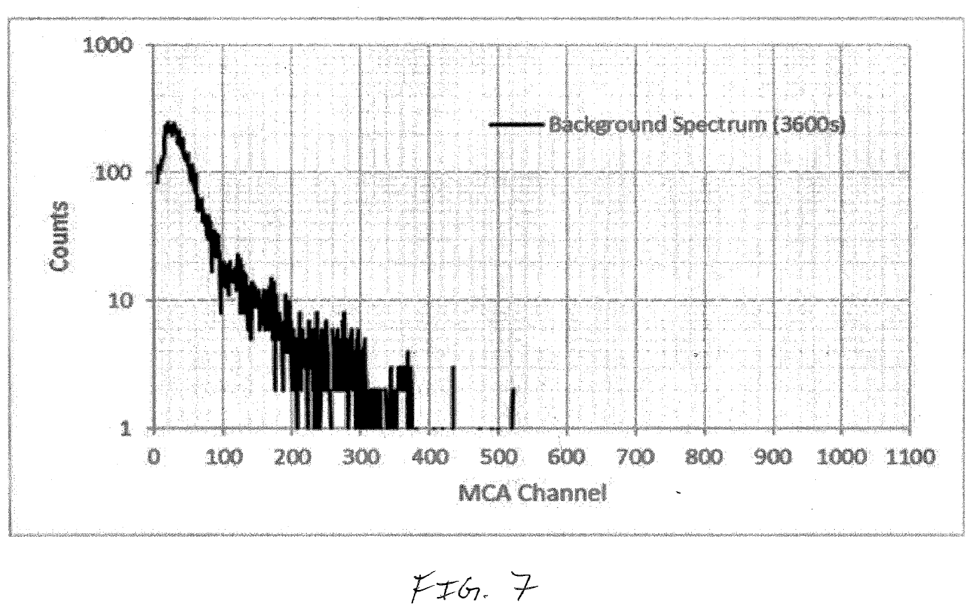

FIG. 7 depicts a spectrum of natural background taken with the inventive radiation detector. The x-axis shows the relative peak height of the signal in channel numbers at the given multi-channel analyzer settings and the y-axis shows the number of counts per channel. The acquisition time was 3600 seconds. Counts per second (cps) were computed by dividing the total number of counts in a region by the acquisition time. The total spectrum contained 11,874 counts over the volume of 1.36 cm³. This resulted in a background count rate of approximately 2.4 cps/cm³, of which most can be contributed to the activity of potassium −40 in the room (the full energy peak of which is just visible at about channel 360) emanating from building materials. Accordingly, the internal activity of the cerium-activated gadolinium pyrosilicate single crystal scintillator material was much smaller than the measured 2.4 cps/cm³. There was no evidence of actinide contamination of the single crystal itself as the number of counts above the 1.46 MeV line was very small. The count rate for energies above the potassium line was less than 0.02 cps/cm³.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

1. A downhole tool deployable in a wellbore that traverses a formation, comprising:
a tool housing configured for movement within and along the wellbore; and
a radiation detector comprising a scintillator material disposed within the tool housing, wherein the scintillator material comprises a cerium-activated gadolinium pyrosilicate.

2. The downhole tool of claim 1, wherein the cerium-activated gadolinium pyrosilicate has a chemical formula of: (Gd_{1-x-y}CeₓA_{y})₂Si₂O₇, wherein:
x is equal to 0.001 to 0.08,
y is equal to 0 or is a number from 0.0001 to 0.079,
if y is >0, A comprises at least one rare-earth element selected from the group consisting of: Sc, Y, La, Pr, Nd, Pm, Sm, Eu, Tb, Dy, Ho, Er, Tm, Yb, and Lu, and
1-x-y is ≥0.92.

3. The downhole tool of claim 2, wherein x is >y.

4. The downhole tool of claim 2 or claim 3, wherein y is 0.

5. The downhole tool of any one of claims 2 to 4, wherein 1-x-y is ≤0.999.

6. The downhole tool of any one of claims 2 to 5, wherein a total amount of any radioactive rare-earth isotopes in the cerium-activated gadolinium pyrosilicate is <5%.

7. The downhole tool of any one of claims 2 to 6, wherein y is >0, and wherein A comprises at least one of La and Lu.

8. The downhole tool of any one of claims 1 to 7, wherein the scintillator material is a single crystal having a volume of at least 1 cm³.

9. The downhole tool of any one of claims 1 to 8, wherein the scintillator material is configured to emit light when the scintillator material absorbs radiation incoming from the formation.

10. The downhole tool of any one of claims 1 to 8, wherein the scintillator material is configured to emit light when the scintillator material absorbs natural gamma-rays incoming from the formation.

11. The downhole tool of claim 9 or claim 10, wherein the scintillator material is configured to emit the light at a light output that varies by less than 20% over a temperature range from 20° C. to 175° C..

12. The downhole tool of claim 9 or claim 10, wherein the scintillator material is configured to emit the light at a light output of at least 20,000 ph/MeV at any temperature within a range from 20° C. to 175° C.

13. The downhole tool of any one of claims 1 to 12, wherein the scintillator material has a primary decay time component of which a decay constant varies by 20% or less at any temperature within a range from 20° C. to 175° C.

14. The downhole tool of any one of claims 1 to 13, wherein the scintillator material has a primary decay time component of less than 120 ns at any temperature within a range from 20° C. to 175° C..

15. The downhole tool of any one of claims 1 to 14, further comprising a radiation source disposed within the tool housing and configured to emit outgoing radiation into the formation, wherein the scintillator material is configured to absorb incoming radiation resulting from interactions between the outgoing radiation and the formation, wherein the radiation source comprises at least one of a neutron source, a gamma-ray source, and an x-ray source.

16-17. (canceled)

18. The downhole tool of any one of claims 1 to 15, further comprising a photodetector disposed within the tool housing and optically coupled to the scintillator material, wherein the photodetector is configured to detect light emitted from the scintillator material.

19. A process for determining at least one property of a formation having a wellbore drilled therein, comprising:
lowering a downhole tool into the wellbore, wherein the downhole tool comprises a tool housing comprising a radiation detector disposed therein, wherein the radiation detector comprises a scintillator material optically coupled to a photodetector, and wherein the scintillator material comprises a cerium-activated gadolinium pyrosilicate;
absorbing natural gamma-rays incoming from the formation with the scintillator material;
emitting light from the scintillator material in response to the absorbed natural gamma-rays;
detecting at least a portion of the light emitted from the scintillator material with the photodetector; and
determining the at least one property of the formation based at least in part on the light detected by the photodetector.

20. The process of claim 19, wherein the photodetector produces a signal in response to the detected light emitted from the scintillator material, and wherein the signal is processed using a pulse shaping filter based on a set of decay time constants that is independent of a temperature the scintillator material is at when the light is emitted therefrom.

21. The process of claim 19, wherein the photodetector produces a signal in response to the detected light emitted from the scintillator material, wherein the signal is processed using a pulse shaping filter in which a single variable that compensates for changes in a set of decay time constants is used, and wherein a range of the single variable can be less than 20% of a total value of the single variable when the scintillator material is at a temperature in a range from 20° C. to 175° C.

22. A process for determining at least one property of a formation having a wellbore drilled therein, comprising:
lowering a downhole tool into the wellbore, wherein the downhole tool comprises a tool housing comprising a radiation detector comprising a radiation source, a scintillator material, and a photodetector disposed therein, wherein:
the scintillator material is optically coupled to the photodetector,
the scintillator material comprises a cerium-activated gadolinium pyrosilicate, and
the radiation source comprises at least one of a neutron source, a gamma-ray source, and an x-ray source;
emitting outgoing radiation from the radiation source into the formation;
absorbing incoming radiation resulting from interactions between the outgoing radiation and the formation with the scintillator material;
emitting light from the scintillator material in response to the absorbed radiation;
detecting at least a portion of the light emitted from the scintillator material with the photodetector; and
determining the at least one property of the formation based at least in part on the light detected by the photodetector.

23-24. (canceled)
